(19) United States
(12) Patent Application Publication
(10) Pub. No.: US 2010/0284892 A1
(43) Pub. Date: Nov. 11, 2010

(54) Process For The Purification Of A Carbon Dioxide Stream With Heating Value And Use Of This Process In Hydrogen Producing Processes

(75) Inventors: Bhadra S. Grover, Sugar Land, TX (US); Pascal Tessier, Wilmington, DE (US)

Correspondence Address: AIR LIQUIDE USA LLC;Intellectual Property, 2700 POST OAK BOULEVARD, SUITE 1800, HOUSTON, TX, 77056, US

(73) Assignee: American Air Liquide, Inc., Fremont, CA (US)

(21) Appl. No.: 12/570,468

(22) Filed: Sep. 30, 2009

Related U.S. Application Data
(60) Provisional application No. 61/215,509, filed on May 6, 2009.

(51) Int. Cl. C01B 31/20

(52) U.S. Cl. 423/437.1

(57) ABSTRACT

The present invention relates to a process for purifying a CO₂ rich gas stream in a catalytic oxidizer. In this process, flammable contaminants that are present in the CO₂ rich gas stream are oxidized when the CO₂ rich gas stream is injected along with a precisely measured amount of substantially pure oxygen into the catalytic oxidizer. As a result, a purified CO₂ rich gas stream is produced which depending upon the amount of oxygen injected contains only minor traces of residual oxygen or minor traces of the flammable contaminants. This process is useful for purifying high-pressure residue streams from membrane water-gas shift reactors, membrane reformers, or sorbent enhanced reformers, where the pressurized CO₂ rich gas stream also contains amounts of hydrogen, methane, and carbon monoxide. The process is also suitable for purifying CO₂ permeate streams from reverse selectivity polymeric membranes that are used to separate CO₂ from gas mixtures that contain CO₂, H₂ and CH₄. In a further embodiment of the present invention, the inlet and outlet temperature of the catalytic oxidizer can be controlled by recycling part of the purified CO₂ rich gas stream to the catalytic oxidizer inlet and/or injecting additional fuel into the catalytic oxidizer. Thereby, a useful amount of heat can be extracted and returned for use anywhere in the CO₂ generating process. The heat obtained via the present process may also be utilized in other processes.

### CROSS-REFERENCE TO RELATED APPLICATIONS

This application claims the benefit of U.S. Provisional Application No. 61/215,509, filed May 6, 2009, the entire contents of which are incorporated herein by reference.

### FIELD OF THE INVENTION

The present invention relates to a process for purifying a carbon dioxide (hereinafter “CO₂”) rich gas stream obtained from a hydrogen plant. The process comprises removing contaminants from the CO₂ rich gas stream by introducing the CO₂ rich gas stream along with oxygen into a catalytic oxidizer thereby allowing for the combustion of the contaminants. The present invention further relates to the capture of heat from this process for purifying a CO₂ rich gas stream that may be used within the hydrogen process or in other processes.

### BACKGROUND

CO₂ is formed when natural gas or other hydrocarbons are used in manufacturing hydrogen. In the past, the CO₂ generated was generally vented to the atmosphere. Recently there has been more emphasis on CO₂ capture and sequestration, as CO₂ is considered to be a greenhouse gas (hereinafter “GHG”). There are many proposed ways to capture CO₂. The purity of the CO₂ captured though can vary depending upon the source of the CO₂ and the actual capture process used. Accordingly, the CO₂ captured may contain impurities such as, for example, hydrogen (hereinafter “H₂”), carbon monoxide (hereinafter “CO”), methane (hereinafter “CH₄”), oxygen (hereinafter “O₂”) and nitrogen (hereinafter “N₂”). The end use of the CO₂ will determine what impurities are acceptable in the CO₂.

Alternative ways of purifying CO₂ have recently been proposed. Catalytic oxidation of carbon monoxide is well known in the field of automotive emissions control. Catalytic oxidation of carbon monoxide is also used in certain air purification processes (see for example, U.S. Pat. No. 4,451,304 and U.S. Pat. No. 6,074,621). U.S. Pat. No. 6,224,843 describes a purification process where a CO₂ stream is heated and passed into a catalytic reactor to oxidize hydrocarbon contaminants, prior to further purification in adsorbent beds in order to remove chlorinated contaminants.

In U.S. Pat. No. 6,669,916, a CO₂ stream containing at least 95% CO₂ is first purified by an adsorption technique to reduce its calorific value. It is subsequently passed in a catalytic reactor to oxidize certain hydrocarbon contaminants with the design being to intentionally allow the majority of the methane to pass through the reactor un-reacted.

U.S. Pat. No. 7,410,531 discloses a hydrogen-producing device comprising a hydrogen-permeable membrane, where the residue is sent to a heating assembly where the residue is combusted to generate a heated exhaust stream that provides heat to the hydrogen-producing section of the device. The combustion region is adapted to receive air for supporting combustion from the fuel cell stack.

Even in view of the above, there still remains a need for a flexible and low cost process to convert contaminated CO₂ streams generated by processes that produce hydrogen from hydrocarbons, while extracting the calorific value of these contaminants in order to maximize the efficiency of the integrated process.

### SUMMARY

The present invention relates to a process for purifying a CO₂ rich gas stream in a catalytic oxidizer. In this process, flammable contaminants that are present in the CO₂ rich gas stream are oxidized when the CO₂ rich gas stream is injected along with a precisely measured amount of substantially pure oxygen into the catalytic oxidizer. As a result, a purified CO₂ rich gas stream is produced which depending upon the amount of oxygen injected contains only minor traces of residual oxygen or minor traces of the flammable contaminants. This process is useful for purifying high-pressure residue streams from membrane water-gas shift reactors, membrane reformers, or sorbent enhanced reformers, where the pressurized CO₂ rich gas stream also contains amounts of hydrogen, methane, and carbon monoxide. The process is also suitable for purifying CO₂ permeate streams from reverse selectivity polymeric membranes that are used to separate CO₂ from gas mixtures that contain CO₂, H₂ and CH₄. In a further embodiment of the present invention, the inlet and outlet temperature of the catalytic oxidizer can be controlled by recycling part of the purified CO₂ rich gas stream to the catalytic oxidizer inlet and/or injecting additional fuel into the catalytic oxidizer. Thereby, a useful amount of heat can be extracted and returned for use anywhere in the CO₂ generating process. The heat obtained via the present process may also be utilized in other processes.

### BRIEF DESCRIPTION OF THE FIGURES

FIG. 1 provides a schematic of the basic process of the present invention.

FIG. 2 provides a schematic in which the process of the present invention is integrated into a hydrogen production process.

FIG. 3 provides a schematic in which the process of the present invention is integrated into an alternative hydrogen production process that includes a hydrogen generator in conjunction with reverse selectivity CO₂ permeable membranes.

FIG. 4 provides a schematic in which the process of the present invention is integrated into a still further hydrogen production process that includes absorbent beds or sorption-enhanced reforming processes using CO₂ adsorbents to separate the various components of a H₂/CO₂ or H₂/CO₂/CO mixture.

### DETAILED DESCRIPTION OF THE INVENTION

The process of the present invention comprises the purification of a CO₂ rich gas stream in a catalytic oxidizer whereby flammable contaminants that are present in the CO₂ rich gas stream are oxidized by injecting a precisely measured amount of substantially pure oxygen along with the CO₂ rich gas stream into the catalytic oxidizer with the result being a purified CO₂ rich gas stream having only minor traces of residual oxygen and/or minor traces of the flammable contaminants. The process of the present invention provides for easier capture of the CO₂ that is generated by industrial processes. It is especially useful for purifying a high-pressure residue stream obtained from a membrane water-gas shift reactor, a membrane reformer, or a sorbent enhanced reformer, each producing a pressurized CO₂ rich gas stream that contains hydrogen, methane, and carbon monoxide. The process is also applicable for purifying a CO₂ permeate stream from reverse selectivity polymeric membranes that separate the CO₂ from gas mixtures that contain CO₂, H₂ and CH₄.

The catalytic oxidizer utilized in the present invention is a reactor that contains a catalyst which functions to accelerate the reaction (in this case oxidation/combustion) and make possible, at a lower temperature, the reaction which would normally take place at a higher temperature. Such catalytic oxidizers are commercially available and are readily known to those skilled in the art. As used herein, the phrase “CO₂ rich gas stream” refers to a gas stream that has greater than about 75 mol % carbon dioxide, preferably from about 85 mol % carbon dioxide to about 99 mol % carbon dioxide, the stream being the product of a membrane water-gas shift reactor, a membrane reformer, a sorbent enhanced reformer or a reverse selectivity polymeric membrane. The remaining components of the CO₂ rich gas stream will be referred to as “contaminants” or “flammable contaminants” which are considered to be combustible contaminants that are contained in the CO₂ rich gas stream; more specifically as used herein, the “contaminants” or “flammable contaminants” refers to the remaining components that make up the CO₂ rich gas stream and comprise hydrogen, carbon monoxide and/or methane. One of the objectives of the present invention is the elimination of the hydrogen, carbon monoxide and methane from the CO₂ rich gas stream as these contaminants can cause a variety of problems when the CO₂ rich gas stream is further used. Accordingly, as used herein, the phrase “minor amounts”, when referencing the flammable contaminants, refers to an amount that is less than about 15 mol % on dry basis, preferably from about 1 to about 15 mol % on dry basis, and alternatively from about 1 to about 10 mol % on dry basis of the CO₂ rich gas stream.

In the process of the present invention, contaminants are removed from the CO₂ rich gas stream through a variety of steps involving a catalytic oxidizer. More specifically, in the process of the present invention, the CO₂ rich gas stream that is utilized can be any carbon dioxide stream that is generated from a membrane water-gas shift reactor, a membrane reformer, a sorbent enhanced reformer or a reverse selectivity polymeric membrane and which contains hydrogen, carbon dioxide and methane as minor components (contaminants) to the CO₂ rich gas stream. More specifically, the present invention is directed to the removal of these contaminants from a CO₂ rich gas stream wherein the total amount of contaminants that are present preferably do not exceed 10 mol % of the CO₂ rich gas stream, even more preferably that do not exceed 5 mol % of the CO₂ rich gas stream. Accordingly, the first step of the process involves the generation of the CO₂ rich gas stream. As noted previously, the present process can be used in conjunction with a variety of hydrogen producing processes which produce a gas stream that is rich in CO₂, such as membrane water-gas shift reactors, membrane reformers, sorbent enhanced reformers or reverse selectivity polymeric membranes. The use of these various processes to produce hydrogen is well known to those skilled in the art. Accordingly, those skilled in the art recognize that the by-product of the production of purified hydrogen gas utilizing membrane water-gas shift reactors, membrane reformers, sorbent enhanced reformers or reverse selectivity polymeric membranes is a gas stream that is rich in CO₂. It is this gas stream which is the by-product of the purified hydrogen gas that can be further treated according to the process of the present invention to achieve a purified CO₂ rich gas stream.

The second step of the process involves introducing a precisely measured amount of substantially pure oxygen into the CO₂ rich gas stream. As used herein, the phrase “substantially pure oxygen” refers to a stream of oxygen gas that has greater than 90% purity, preferably greater than 95.0% purity, more preferably greater than 99.5% purity and even more preferably greater than 99.8% purity. The reasoning behind utilizing such a pure stream is that argon and nitrogen, the common impurities in oxygen streams could lead to the addition and ultimate increase in the impurities in the treated or purified CO₂ rich gas stream. The phrase “precisely measured” refers to measurement by any methodology that is considered to be standard and acceptable for measuring the percent purity of a gas such as CO₂.

With regard to the amount of oxygen utilized (the amount that is introduced to or added to the CO₂ rich gas stream), this amount will be determined by stoichiometric calculations based on the quantity of impurities in the CO₂ rich gas stream to be treated. More specifically, the amount will be a quantity that is sufficient to allow complete combustion of the flammable contaminants in the CO₂ rich gas stream. Accordingly, the amount of oxygen used can be slightly more than calculated when it is desirable to have trace amounts of oxygen residue present rather than trace amounts of combustible contaminants and slightly less than calculated when it is desirable to have trace amounts of combustible contaminants present rather than trace amounts of oxygen residue. In a preferred embodiment, the ratio of oxygen to CO₂ rich gas stream is slightly below the stoichiometric value in order to control residual hydrocarbons in the purified CO₂ to be in the range of from about 10 to about 10,000 ppm, even more preferably from about 10 to about 1000 ppm. In an alternative preferred embodiment, the ratio of oxygen to CO₂ rich gas stream is slightly above the stoichiometric value in order to completely destroy all hydrocarbons and control residual O₂ in the purified CO₂ to be in the range of from about 10 to about 1000 ppm, preferably from about 10 to about 100 ppm.

As noted previously, the oxygen is injected (or mixed) into the CO₂ rich gas stream and the resulting combined oxygen/CO₂ rich gas stream is then injected into the catalytic oxidizer where the contaminants will combust and produce a purified CO₂ rich gas stream that contains a small amount of water and trace amounts of either oxygen residue or trace amounts of flammable contaminants. Note that in some instances, the resulting purified CO₂ rich gas stream from the catalytic oxidizer may contain substantial amounts of water (hereinafter “H₂O”) that result from the oxidation of H₂ or CH₄ (or other hydrocarbons). However, the H₂O can be easily separated by condensation upon cooling and phase separation, or other drying process known to those skilled in the art. Once the purified CO₂ rich gas stream is dried, the resulting stream will be a dried pure CO₂ rich gas stream. Those skilled in the art will recognize that depending on the amount of H₂O present, it may be advantageous to remove the H₂O (dry the purified CO₂ rich gas stream) prior to further treatment. It should also be noted that the raw CO₂ stream may also contain an amount of water (vapor). Those of ordinary skill in the art will further recognize that the water in the raw CO₂ stream can be separated from the raw CO₂ stream in any number of manners known in the art, including simultaneously with the stream generated in the catalytic oxidizer.

Preheating of the catalytic bed may be required to initiate the reaction. The minimum catalyst temperature for initiating the reaction varies with the catalyst selected. Catalyst vendors typically advise the minimum preheat temperature. The preheating can be done by various known methods, such as for example, passing hot inert gas (e.g. N₂) through the catalyst bed. The catalytic oxidizer utilized in the present invention may be any catalytic oxidizer that is readily known to those skilled in the art. The actual configuration of the catalytic oxidizer is not especially critical to the invention provided that such catalytic oxidizers include an inlet for injecting the combined oxygen/CO₂ rich gas stream and an outlet for withdrawing the purified CO₂ rich gas stream. In the preferred embodiment, the catalytic oxidizer will have one or more beds of a catalyst that is selective for combusting the flammable contaminants contained in the oxygen/CO₂ rich gas stream. Preferably, the catalyst utilized will be selected from a platinum metal or a palladium metal on a suitable support, preferably a platinum metal. Suitable supports include, but are not limited to, various types of alumina supports and other ceramics. The catalyst utilized may be organized in the catalytic oxidizer in any manner known in the art, such as in fixed beds. Such catalysts and their inclusion in catalytic oxidizer reactors are readily known to those skilled in the art and are commercially available. Once the flammable contaminants have been combusted, the hot purified CO₂ rich gas stream is withdrawn from the catalytic oxidizer and is passed on to be used for heat recovery.

In an alternative embodiment of the present invention, the temperature of the oxygen/CO₂ rich gas stream as it is injected into the inlet of the catalytic oxidizer, as well as the temperature at the outlet where the purified gas stream is withdrawn, can be controlled by recycling part of the purified CO₂ rich gas stream, at a chosen temperature, to the inlet of the catalytic oxidizer. Such temperature control is typically necessary to protect catalysts from overheating and to provide minimum temperature required for the oxidative reaction to start. Heat generated in the catalytic oxidizer can be extracted from the purified CO₂ rich gas stream by use of one or more heat exchangers. Furthermore, the extracted heat can be used anywhere with regard to the processes that generate the CO₂ rich gas streams or for other uses such as within other non-related processes. Additional combustible gas, such as hydrogen, carbon monoxide, natural gas, pure methane, or other hydrocarbons that only generate CO₂ or water when oxidized, can be injected along with the mixture of the CO₂ rich gas stream and oxygen into the catalytic oxidizer in order to increase the level of heat (by increasing the outlet temperature) that can be extracted from the purified stream, if required.

CO₂ rich gas streams generated by membrane water-gas shift reactors, membrane reformers, and sorbent enhanced reformers are typically produced at a temperature in the range of from about 300° C. to about 700° C., preferably from about 500° C. to about 600° C., and typically contain un-reacted methane, non-permeated (or adsorbed) hydrogen, and a small amount of un-converted carbon monoxide, as shown for example in the article by Shirasaki et al where this off-gas is burned in air and vented to the atmosphere. (See, Development of Membrane Reformer System For Highly Efficient Hydrogen Production From Natural Gas, International Journal of Hydrogen Energy 34 (2009) 4482-4487; see also Patil et al, Experimental Study of A Membrane Assisted Fluidized Bed Reactor For H₂ Production By Steam Reforming of CH₄, Chemical Engineering Research and Design, 84(A5): 399-404 (2006). The use of a catalytic oxidizer maintains or enhances the level of heat available in the purified stream. The high level of heat available can be used for the generation of high pressure steam, superheat steam, reforming of hydrocarbons, preheating of natural gas and steam mixtures used as feedstocks for hydrogen production, preheat combustion air for the hydrogen generator, provide heat for the regeneration of CO₂ sorbent beds or for other process uses. This in turn enhances the thermal efficiency of the process. The alternative to the catalytic oxidizer being the source of high level heat is to provide a dedicated fired heater for raising high pressure steam and preheating of process streams to the desired temperature for reforming. Thus, the catalytic oxidizer eliminates the need for a dedicated fired heater.

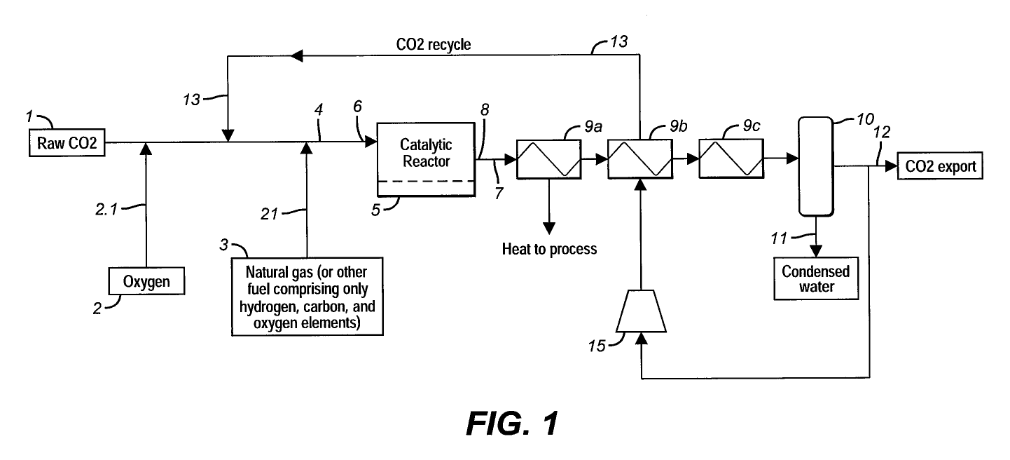

One embodiment of the CO₂ purification process of the present invention is shown in the flow chart of FIG. 1. In FIG. 1, a raw CO₂ stream 1 (also referred to herein as a CO₂ rich gas stream) containing flammable contaminants such as methane and hydrogen is mixed with an oxygen source 2 via line 2.1 and passed along line 4 to the catalytic oxidizer reactor 5. Optionally, purified CO₂ (such as, for example CO₂ recycled from the outlet 8 of the catalytic oxidizer reactor 5) and/or additional fuel such as methane (natural gas) 3 are added to the combined raw CO₂/oxygen stream line 4 via lines 13 and 21, respectively. This combined stream 4 is injected in a catalytic oxidizer reactor 5 via an inlet 6 where the flammable components are oxidized as described hereinbefore. The purified CO₂ rich gas stream exiting the catalytic oxidizer reactor 5 via the outlet 8 is passed along line 7 through one or more heat exchangers (depicted as 9a, 9b, 9c in the present embodiment), allowing for the extraction of useful heat, and is then passed through a water separator 10 which allows for the extraction of condensed water via line 11. The purified CO₂ rich gas stream can then be exported via line 12 as such or further purified and/or liquefied. Part of the purified CO₂ rich gas stream can be recycled via line 13. The temperature of this recycled stream is optionally increased by heat exchange (not shown) with the hot raw CO₂ rich gas stream. In addition, prior to being mixed with the raw CO₂ rich gas stream, the CO₂ recycled stream can be slightly compressed in a cycle compressor 15.

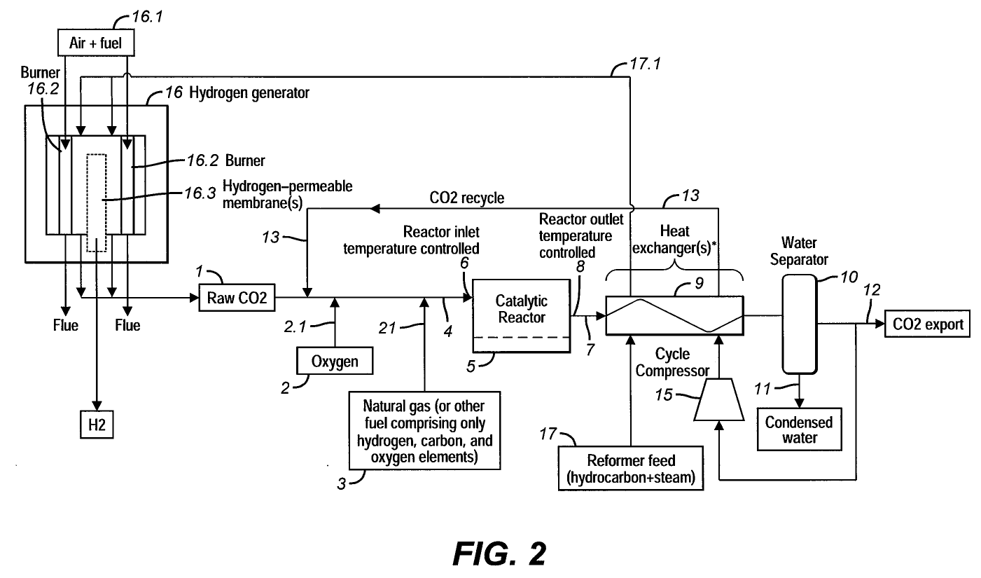

An example of an integrated hydrogen production process using the process of the present invention is shown in FIG. 2. As can be seen from FIG. 2, in this embodiment, the raw CO₂ rich gas stream 1 originates from a membrane reformer-type hydrogen generator 16. The heat exchangers 9 positioned downstream of the catalytic oxidizer reactor 5 are used to heat up the reformer feed mix 17 (hydrocarbon feedstock and steam), fuel and/or air supplied to the hydrogen generator 16 via line 17.1. The raw CO₂ 1 produced in the hydrogen generator 16 is then utilized in the process as described above with regard to FIG. 1. While a certain type of hydrogen generator is depicted in FIG. 2 (one containing a variety of burners 16.2 with paths for gases including flue gases, hydrogen-permeable membrane(s) 16.3, and an external source of air and fuel 16.1), those skilled in the art will recognize that it is understood that other types of hydrogen generators 16 producing a CO₂ rich gas stream with flammable contaminants such as those set forth specifically in the present invention can benefit from the present invention.

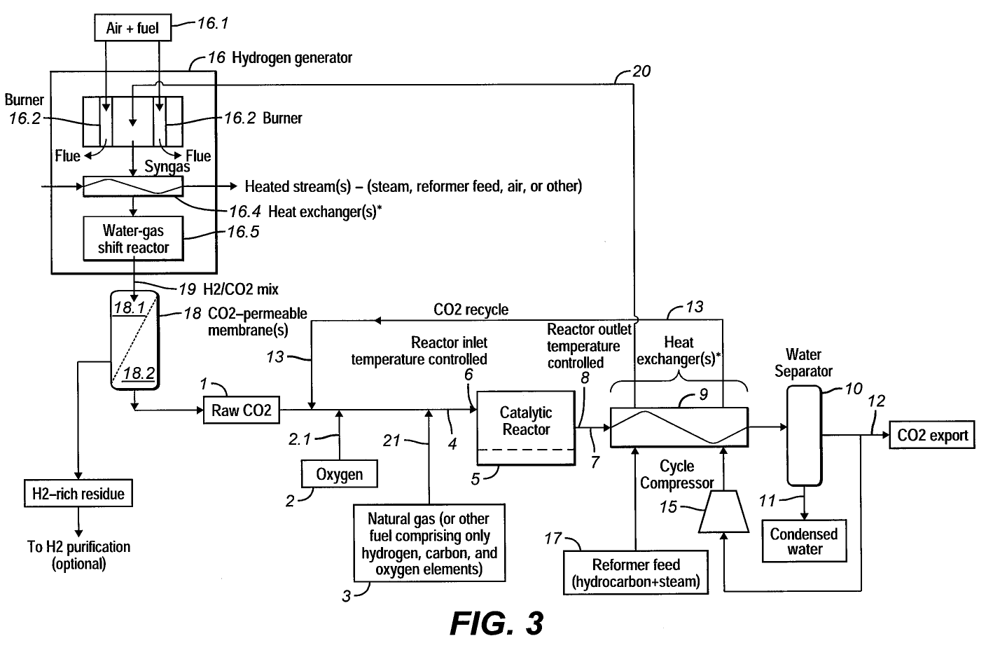

In an alternative embodiment of the present invention as shown in FIG. 3 the process of the present invention is used for purification of a CO₂ rich gas stream from a CO₂ permeable membrane 18 (also commonly referred to as reverse selectivity membranes) which includes a feed side of the membrane 18.1 and a permeate side of the membrane 18.2. In certain embodiments of the present invention, multiple CO₂ permeable membranes may be utilized. These types of membranes 18 are typically made of a polymer-type material such as, but not limited to, polyethylene oxide (PEO) or silicon rubber and their selectivity to CO₂ is much lower than the selectivity of Pd-based membranes to hydrogen. The CO₂ rich gas stream obtained from a hydrogen generator 16 such as that disclosed in FIG. 3 using reverse-selectivity membranes 18 for extraction of CO₂ from the H2-rich gas stream 19 invariably contains significant hydrogen and methane contaminants. The amount of H₂ and CH₄ in CO₂ can be reduced by compressing (compressor not shown) the permeate of the first stage 18.1 of the membrane and passing it through a second stage 18.2 of reverse selectivity membrane. Using the CO₂ permeable membrane, a first stream of H₂ rich membrane residue is removed from the feed side of the permeable membrane 18 (the material that does not pass through the membrane). The remaining portion of the H₂/CO₂ mix 19 (the CO2 rich permeate) passes through the membrane to the permeate side the membrane 18.2 to become the raw CO₂ stream 1. While a certain type of hydrogen generator is depicted in FIG. 3, (one containing a variety of burners 16.2 with paths for the flue gases and syngases, heat exchangers 16.4, a water gas shift reactor 16.5 and an external source of air and fuel 16.1), those skilled in the art will recognize that it is understood that other types of hydrogen generators 16 producing a CO₂ rich gas stream with flammable contaminants such as those set forth specifically in the present invention can benefit from the present invention. The present invention is extremely useful in terms of purifying the CO₂ stream and extracting its calorific value to provide heat for the H₂-generating process (note as an example heat from the heat exchangers 9 is used to supply heat to the hydrogen generator 16 via line 20).

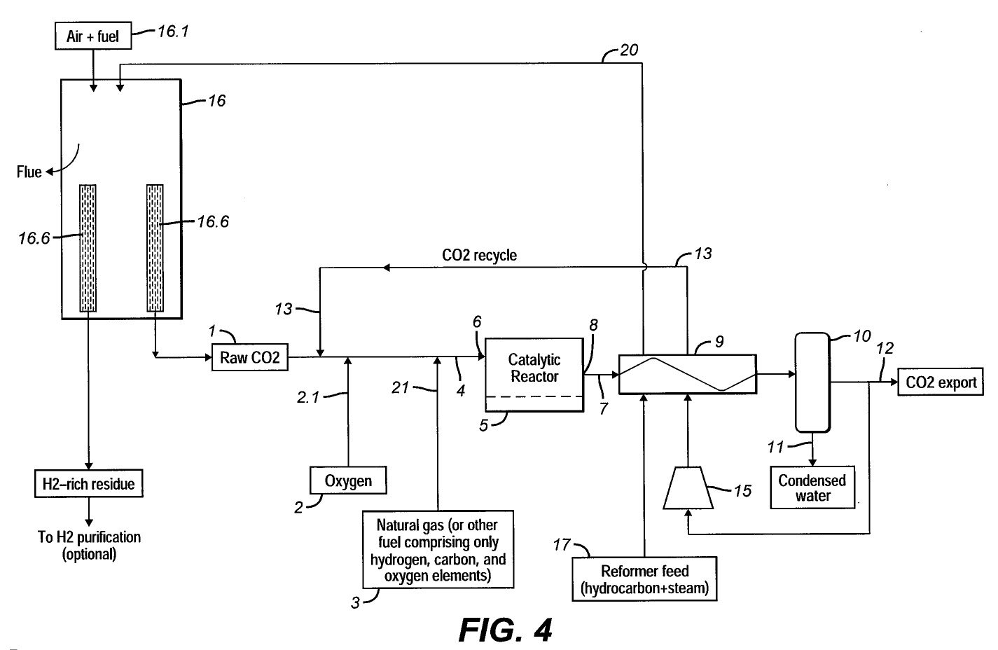

It is clear that other types of hydrogen-generating processes from which a CO₂ rich gas stream is extracted can benefit from the use of the process of the present invention to purify the CO₂, extract its useful heat, and even use this CO₂ purification system for injecting more heat into the overall process by adding required amounts of hydrocarbon fuel and oxygen to the catalytic oxidizer reactor 5 as an integral part to this invention. Such other processes may include processes where the components of a H₂/CO₂ or H₂/CO₂/CO mixture are separated in an absorbent bed 16.6, or sorption-enhanced reforming processes using metal hydrides for hydrogen sorption or various carbonates for CO₂ sorption (such as shown in FIG. 4). Given that these new membrane- or sorption-enhanced hydrogen-producing processes are often operated at lower temperatures than conventional steam-methane reforming, the CO₂ purification/heat recovery process of the present invention provides a source of high-temperature heat that would otherwise not be available for steam production or other stream heating requirements.

Elements depicted in the Figures:
1. raw CO₂ stream
2. oxygen
2.1 line to supply oxygen
3. natural gas supply
4. line taking mixture of raw CO₂ stream and oxygen to the catalytic oxidizer reactor
5. catalytic oxidizer reactor
6. inlet of catalytic oxidizer reactor
7. line carrying purified CO₂ rich gas stream to the heat exchangers
8. outlet of catalytic oxidizer reactor
9. heat exchanger(s) (depicted as 9 when one or in the case of multiple heat exchangers 9a, 9b and 9c)
10. water separator
11. line for condensed water removed from water separator
12. line for CO₂ export
13. line allowing for CO₂ recycle (recycle of purified CO₂ rich gas stream)
15. cycle compressor
16. hydrogen generator
16.1 source of air and fuel
16.2 burner(s)
16.3 hydrogen-permeable membrane(s)
16.4 hydrogen generator heat exchanger(s)
16.5 water gas shift reactor
16.6 sorbent bed(s)
17. reformer feed mix
17.1 line to supply fuel and/or air to the hydrogen generator
18. CO₂ permeable membrane(s)
19. H₂/CO₂ rich gas stream
20. line where heat from the heat exchanger(s) is supplied to the hydrogen generator
21. line where natural gas is supplied to the line that supplies the raw CO₂ stream and oxygen mixture to the catalytic oxidizer reactor

What is claimed is:

1. A process for removing contaminants from a CO₂ rich gas stream, said process comprising the steps of:
a. generating a CO₂ rich gas stream that contains CO₂ and a minor amount of flammable contaminants selected from hydrogen, carbon monoxide and methane;
b. introducing substantially pure oxygen into the CO₂ rich gas stream to produce a combined oxygen/CO₂ rich gas stream;
c. injecting the combined oxygen/CO₂ rich gas stream into a catalytic oxidizer reactor having one or more beds of a catalyst that is selective for combusting the flammable contaminants contained in the combined oxygen/CO₂ rich gas stream in order to combust the contaminants contained in the combined oxygen/CO₂ rich gas stream and produce a hot purified CO₂ rich gas stream, the oxygen/CO₂ rich gas stream being injected into the catalytic oxidizer reactor at a temperature that is sufficient to allow for the combustion of the contaminants in the CO₂ rich gas stream;
d. withdrawing the hot purified CO₂ rich gas stream; and
e. using the hot purified CO₂ rich gas stream for one or more of the following: raise steam, superheat steam, reforming of hydrocarbons, preheat natural gas and steam mixtures used as feedstocks for hydrogen production, preheat combustion air for the hydrogen generator or provide heat for the regeneration of CO₂ sorbent beds.

2. The process of claim 1, wherein the CO₂ rich gas stream is obtained from a membrane water-gas shift reactor, a membrane reformer, a sorbent enhanced reformer or a reverse selectivity polymeric membrane.

3. The process of claim 1, wherein the combined oxygen/CO₂ rich gas stream injected into the catalytic oxidizer is injected at a temperature of from about 300° C. to about 700° C.

4. The process of claim 1, wherein the minor amount of contaminants comprises from about 1 to about 15 mol % on dry basis of the CO₂ rich gas stream.

5. The process of claim 1, wherein the substantially pure oxygen comprises a 95% purity or greater amount of oxygen.

6. The process of claim 1, wherein the ratio of oxygen to CO₂ rich gas stream is slightly below the stoichiometric value in order to control residual hydrocarbons in the purified CO₂ to be in the range of from about 10 to about 10,000 ppm.

7. The process of claim 1, wherein the catalyst of the catalytic oxidizer is a platinum metal or a palladium metal on a suitable support.

8. The process of claim 1, wherein the process further comprises injecting natural gas into the catalytic oxidizer along with the oxygen/CO₂ rich gas stream.

9. The process of claim 1, wherein the ratio of oxygen to CO₂ rich gas stream is slightly above the stoichiometric value in order to completely destroy all hydrocarbons and control residual O₂ in the purified CO₂ to be in the range of from about 10 to about 1000 ppm.

10. The process of claim 2, wherein the combined oxygen/CO₂ rich gas stream injected into the catalytic oxidizer is injected at a temperature of from about 300° C. to about 700° C. and the substantially pure oxygen comprises a 95% purity or greater amount of oxygen.

11. The process of claim 10, wherein the minor amount of contaminants comprises from about 1 to about 15 mol % on dry basis of the CO₂ rich gas stream.

12. The process of claim 11, wherein the ratio of oxygen to CO₂ rich gas stream is slightly below the stoichiometric value in order to control residual hydrocarbons in the purified CO₂ to be in the range of from about 10 to about 10,000 ppm.

13. The process of claim 11, wherein the ratio of oxygen to CO₂ rich gas stream is slightly above the stoichiometric value in order to completely destroy all hydrocarbons and control residual O₂ in the purified CO₂ to be in the range of from about 10 to about 1000 ppm.

14. A process for removing contaminants from a CO₂ rich gas stream produced in a hydrogen plant, said process comprising the steps of:
a. generating a CO₂ rich gas stream from a hydrogen generator, said CO₂ rich gas stream containing CO₂ and a minor amount of flammable contaminants selected from hydrogen, carbon monoxide and methane;
b. introducing substantially pure oxygen into the CO₂ rich gas stream to produce a combined oxygen/CO₂ rich gas stream;
c. injecting the combined oxygen/CO₂ rich gas stream into a catalytic oxidizer reactor having an inlet and an outlet and one or more beds of a catalyst that is disposed between the inlet and outlet, the one or more beds of catalyst being selective for combusting the flammable contaminants contained in the combined oxygen/CO₂ rich gas stream in order to combust the contaminants contained in the combined oxygen/CO₂ rich gas stream and produce a hot purified CO₂ rich gas stream, the combined oxygen/CO2 rich gas stream being injected into the catalytic oxidizer reactor at the inlet of the catalytic oxidizer reactor and at a temperature that is sufficient to allow for the combustion of the contaminants in the CO₂ rich gas stream;
d. withdrawing the hot purified CO₂ rich gas stream from the outlet of the catalytic oxidizer reactor;
e. passing the hot purified CO₂ rich gas stream through one or more heat exchangers in order to capture the heat from the hot purified CO₂ rich gas stream for use to either raise steam, superheat steam, reforming of hydrocarbons, preheat natural gas and steam mixtures used as feedstocks for hydrogen production, or preheat combustion air for the hydrogen generator, or provide heat for the regeneration of CO₂ sorbent beds;
f. further passing the heat exchanged purified CO₂ rich gas stream to a water separator in order to condense and remove water from the heat exchanged purified CO₂ rich gas stream and produce a purified CO₂ rich gas stream; and
g. recycling a portion of the purified CO₂ rich gas stream to the combined oxygen/CO₂ rich gas stream in order to adjust and control the temperature at the inlet and outlet of the catalytic oxidizer reactor and withdrawing the remaining portion of the purified CO₂ rich gas stream for further use.

15. The process of claim 14, wherein the CO₂ rich gas stream is generated from a hydrogen generator in combination with either a membrane water-gas shift reactor, a membrane reformer, a sorbent enhanced reformer or a reverse selectivity polymeric membrane.

16. The process of claim 14, wherein the combined oxygen/CO₂ rich gas stream injected into the catalytic oxidizer is injected at a temperature of from about 300° C. to about 700° C.

17. The process of claim 14, wherein the minor amount of contaminants comprises from about 1 to about 15 mol % on dry basis of the CO₂ rich gas stream.

18. The process of claim 14, wherein the substantially pure oxygen comprises a 95% purity or greater amount of oxygen.

19. The process of claim 14, wherein the ratio of oxygen to CO₂ rich gas stream is slightly below the stoichiometric value in order to control residual hydrocarbons in the purified CO₂ to be in the range of from about 10 to about 10,000 ppm.

20. The process of claim 14, wherein the catalyst of the catalytic oxidizer is a platinum metal or a palladium metal on a suitable support.

21. The process of claim 14, wherein the process further comprises injecting natural gas into the catalytic oxidizer along with the oxygen/CO₂ rich gas stream.

22. The process of claim 14, wherein the ratio of oxygen to CO₂ rich gas stream is slightly above the stoichiometric value in order to completely destroy all hydrocarbons and control residual O₂ in the purified CO₂ to be in the range of from about 10 to about 1000 ppm.

23. The process of claim 15, wherein the combined oxygen/CO₂ rich gas stream injected into the catalytic oxidizer is injected at a temperature of from about 300° C. to about 700° C. and the substantially pure oxygen comprises a 95% purity or greater amount of oxygen.

24. The process of claim 23, wherein the minor amount of contaminants comprises from about 1 to about 15 mol % on dry basis of the CO₂ rich gas stream.

25. The process of claim 24, wherein the ratio of oxygen to CO₂ rich gas stream is slightly below the stoichiometric value in order to control residual hydrocarbons in the purified CO₂ to be in the range of from about 10 to about 10,000 ppm.

26. The process of claim 24, wherein the ratio of oxygen to CO₂ rich gas stream is slightly above the stoichiometric value in order to completely destroy all hydrocarbons and control residual O₂ in the purified CO₂ to be in the range of from about 10 to about 1000 ppm.
